(19) United States
(12) Patent Application Publication
(10) Pub. No.: US 2013/0098919 A1
(43) Pub. Date: Apr. 25, 2013

(54) PRESSURE TANK

(71) Applicant: Grzegorz Jarzynski, Radzyn Chelminski (PL)

(72) Inventor: Grzegorz Jarzynski, Radzyn Chelminski (PL)

(73) Assignee: ELPIGAZ SP. Z O.O., GDANSK (PL)

(21) Appl. No.: 13/806,366

(22) PCT Filed: Oct. 6, 2010
(86) PCT No.: PCT/PL2010/050051

§ 371 Date: Dec. 21, 2012

(51) Int. Cl. F17C 1/00

(52) U.S. Cl. CPC F17C 1/00
USPC 220/566

(57) ABSTRACT

Subject of the invention is pressure tank, especially three-bottoms tank, creating beneficially toroidal tank, comprising connected bottoms, equipped with connector pipes for installation, brackets for fastening the tank and cover, type plate, equipment equipment cover, inner bottom, inner shell, divider and is characterized by that the outer, upper bottom (1) together with outer, lower bottom (2) create outer tank shell, whereas inner bottom (4) is connected with the inner shell (3), creating the central, inner part (S) of the tank, and connector pipes (9, 9a, 9b and 14) and flow connectors (15, 15a) have on their length two zones: zone A with walls of increased thickness and zone B—with walls of reduced thickness, beneficially on the whole circumference of connector, whereas the wall thickness in zone B is between 0.5 up to 1.7 of the thickness of tank elements when the wall thickness is between 0.01 up to 2.9 mm and 0.3 up to 1.4 for walls thick above 2.90 mm.

Subject of the invention is pressure tank, especially three-bottoms tank, especially for volatile gases, liquid pressure gases and liquids, air, used in cars, rail vehicles, machines, stationary or mobile devices, as integral element of the unit or the unit itself.

There is known, from international patent application PCT No WO9846443, the flat tank for liquid gas, where two shells, upper and lower, have centrally welded conical, upper and lower flanges, connected together by the tube, with the holes equally located on the circumference.

There is also known, from description of Polish application No P-354299, gas tank, especially for liquid propane-butane, consisting of together fixed, profiled shells, upper and lower, as well as profiled middle tube, whereas the central tube has two through holes and two additional closing shells, and one shell has a connector pipe. The tank is characterized in that in one of additional central shells there is a valve with the tube in vertical axis of the tank, having exactly defined height in relation to central shell.

There is known, from Polish patent description No 192015 toroidal tank for propane-butane, consisting of primary tank with connector for valve group on the outer shell, characterized in that it has two central shells, upper and lower, located in the center, free space of primary tank and has through holes in the inner shell of primary tank.

There is known, from description of Polish patent application No P-381926 toroidal tank for liquid pressure gas, equipped with the hole for multi-valve head, brackets for fixing the upper plate, located on upper part of the tank and the lower plate, which has a hole with tube segment, characterized in that the toroidal tank is coupled to the chassis of vehicle by at least one, beneficially centrally located, beneficially threaded on the one end, tube for ventilation and fixing. The tube is fixed on the upper end with the lower plate, whereas the lower end is coupled to vehicle chassis, beneficially with the nut and washer.

There is known from description of Polish application No P-384134 the four-bottoms tank, creating beneficially toroidal tank, containing connected bottoms, equipped with connecting pipes, brackets for fastening the tank and cover, equipment cover, central joint with holes and central tube, characterized by that it comprises tightly connected at least four bottoms, where the outer, upper bottom creates with the outer, lower bottom the outer shell of the tank, whereas the inner, upper bottom, connected with the inner, lower bottom by the central tube and beneficially inner shell with holes, create the central joint, comprising additional work space.

Pressure tank, especially three-bottoms tank, according to the invention, creating beneficially toroidal tank, comprising connected together bottoms, equipped with connecting pipes, brackets for fastening the tank and cover, type plate, equipment cover, inner bottom, inner shell, divider, is characterized by that the outer, upper bottom together with the outer, lower bottom create the outer tank shell, whereas inner bottom is connected with the inner shell, creating the central, inner part of the tank. The inner shell of the tank, in specific case may have the shape of the tube , with the weld seam or without, the tube produced by rolling the sheet or few sheets, or the cone or truncated cone with different angles of side walls to the cone base, cylinder with the bottom or without the bottom, which may be straight or bend Inner bottom or bottom used for inner shell and/or divider may have the shape of a sphere with different radius or more than one radius and/or truncated cones with different diameters of the base and the top and different angle of side walls to the cone base, with top welded or stamped, or the top open, not closed by any plane and/or cylinders with bottoms welded or stamped this way, that they create cylinder with bottom, being the round or shaped plate. In the standard alternative of invention, as result of connection of outer upper and lower bottoms with inner bottom and/or inner shell, toroidal tank is produced. Equipment connector pipes and flow connector pipes have on their lengths two zones: zone A—with walls of increased thickness and zone B—with walls of reduced thickness, beneficially on the whole circumference of connector, at the same moment thickness in zone B equals 0.5 to 1.7 of the thickness of tank walls, where the connector is placed, in case of walls thick 0.01 up to 2.9 mm and 0.3-1.4 for thickness of walls above 2.9 mm.

In the second alternative of invention, the central tank part is welded between the outer upper and lower bottoms, containing the inner bottom and/or outer shell.

Beneficially, connector pipes are welded to elements of the tank wall this way, that the lower end of A zone has a distance X to the wall of inner shell at least ⅕ of outer diameter of connector D, and length of the weld seam connecting the thin wall of connector outside of A zone, with the tank wall, equals at least ¼ of outer circumference of connector in B zone.

Beneficially, in the central tank part, in the inner and/or outer bottom, divider upper and/or lower are welded.

Beneficially, flow connectors are welded in inner bottom and/or upper divider this way, that part of flow connector with walls having the thickness 0.3 up to 1.7 of element walls, where it is welded, has weld seam with tank elements, which is long at least ¼ of outer circumference of connector, there where his diameter is minimum.

Moreover, beneficially, equipment connector pipes are welded to outer shell and/or inner bottom of central part of the tank and/or in upper and lower divider and/or outer shell and/or outer, upper and lower bottoms.

Beneficially, equipment connector pipes are located circumferentially in the inner shell and/or located in inner bottom and/or upper and lower divider and/or outer shell and/or outer upper and lower bottom.

Flow connector pipes are located in tank elements, which create walls between particular tank parts, are located circumferentially in outer shell and/or in inner bottom and/or in upper and lower bottom.

Beneficially, there is a type plate, fixed to inner bottom and/or upper and lower divider, at the small distance to tank walls, beneficially fixed spot wise.

Beneficially, the type plate, has bends on the edges and/or brackets located under the plate.

Beneficially, to outer upper bottom and/or lower, are welded circumferencially connector pipes for equipment, at the angle 0° up to 355° and placed at angle γ in the range 0° up to 90° to horizontal plane and angle β between the connector pipes is between 0° up to 355°, whereas the connector pipes may be equipped with separate gas-tight housings and/or integrated housing, created by connecting housing of particular connector pipes by tubes.

Beneficially, elements of central inner part of the tank and of others constructions like internal part of the tank and parts being in contact with working medium have the thickness 3 mm or less.

Beneficially, inner bottom and/or upper and lower divider may have places for engraving, replacing this way type plate.

Brackets for fixing base of the cover and/or cover of gas-tight chamber, may be fixed to the surface of inner bottom and/or the inner shell and/or upper and lower divider and/or outer bottoms.

Beneficially, gas-tight cover is fixed by elastic elements made from coiled wire and/or elastic flat bar, fastened to inner bottom and/or inner shell and/or outer bottoms and/or divider, beneficially self pressuring base of cover and/or chamber cover with tank equipment and/or cover seal.

Pressure tank, according to the invention, thanks to introduction of central part as in description for the invention, allows for reduction of materials necessary for production of the tank and better tests and research parameters, when compared with the tanks available on the market, with similar size and purpose. Appropriate selection of thickness for particular tank elements and beneficial technology for preparation assures, when compared to known design of toroidal tanks comprising of two outer bottoms fixed together by one inner element—for example central tube, bigger volume increase reached by lower pressure. Design of three bottoms tank increases the safety thanks to bigger volume increase before blowout, that means relation of volume increase in percents before blow out to pressure of blowout is bigger and allows for reduction of material quantity for the tank with similar outer size, volume, work parameters and purpose.

Thanks to appropriate selection of size and wall thickness of particular tank elements, design of three bottoms tank, described here, allows for changes of relation of volume increase in percent before the blowout to pressure at blowout—that means volume increase reached at particular blowout pressures, changes of blowout pressures according to requirements for particular tank application and to required volume increase before blowout and/or tank content flowout.

The inner bottom and/or inner shell and/or divider of central part of the tank, are part of tight chamber housing with tank equipment. Tank equipment and pipes installed in inner bottom and/or inner shell and/or divider, may beneficially be within tank maximum outer dimensions that means defined by surfaces of outer, upper and lower bottoms and/or outer shell.

Pointwise fixing of type plate, with bended edges, instead of welding to the tank elements, makes it more easy and speeds up following operations in production process (welding, washing, painting) what brings measurable production savings.

The type plate may be the inner bottom and/or dividers, on surface of which data on product and/or producer are placed, according to the rules governing the particular usage of the tank

The tank according to the invention, may be installed with appropriate equipment in any plane, vertically or horizontally, according to the needs.

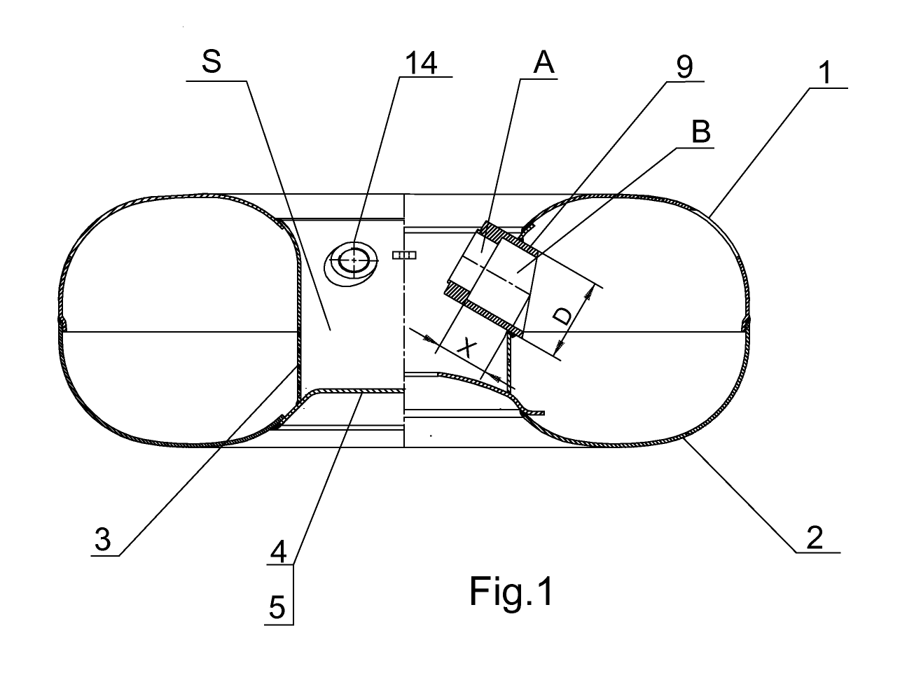

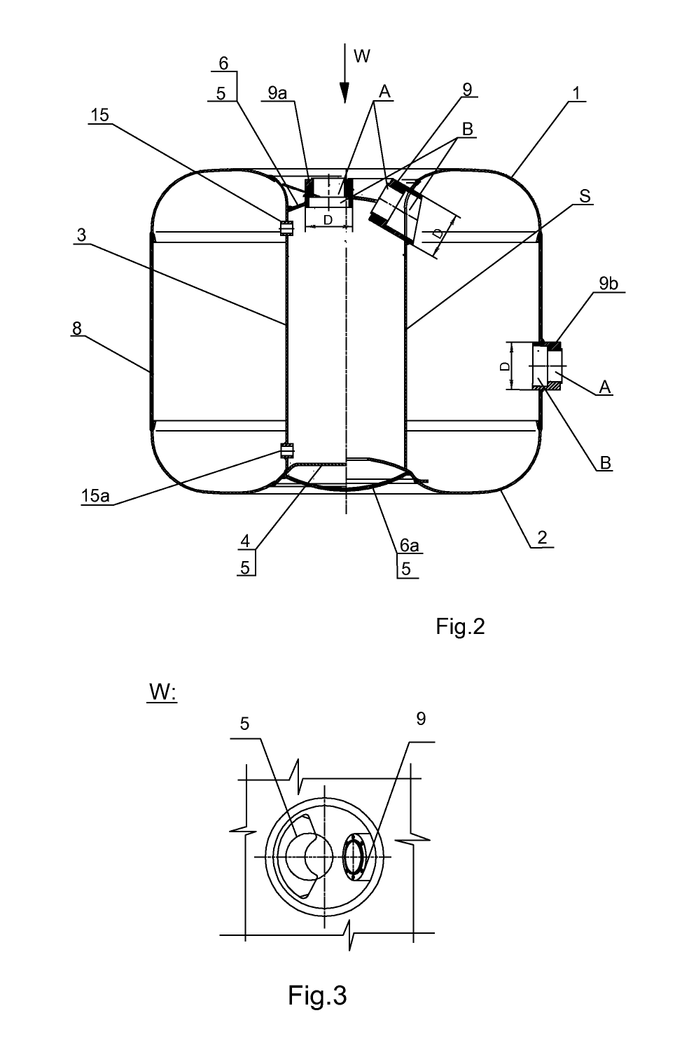

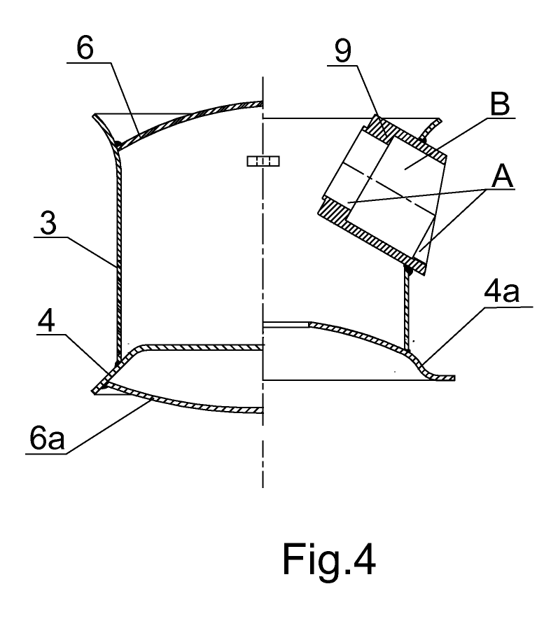

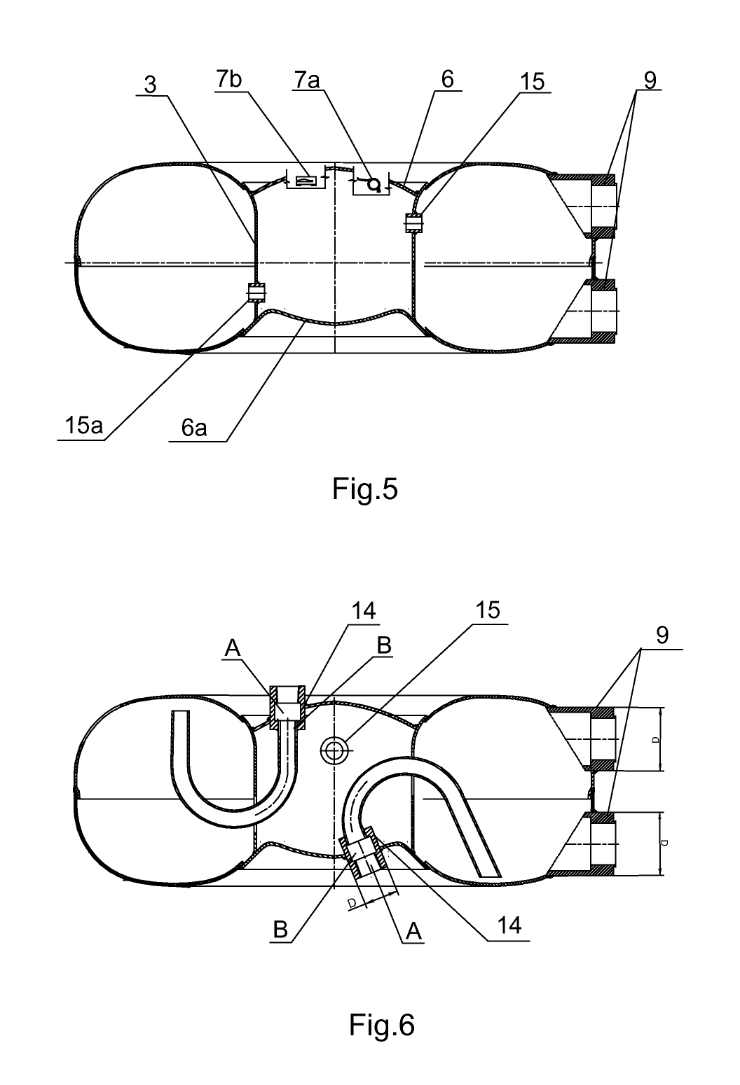

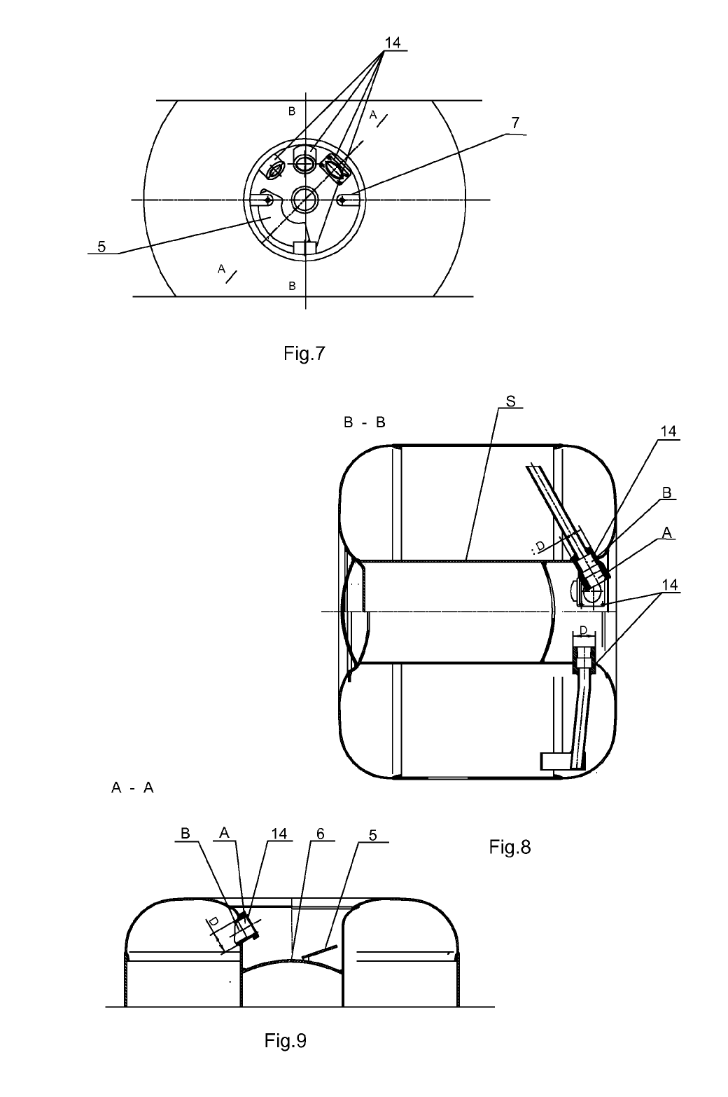

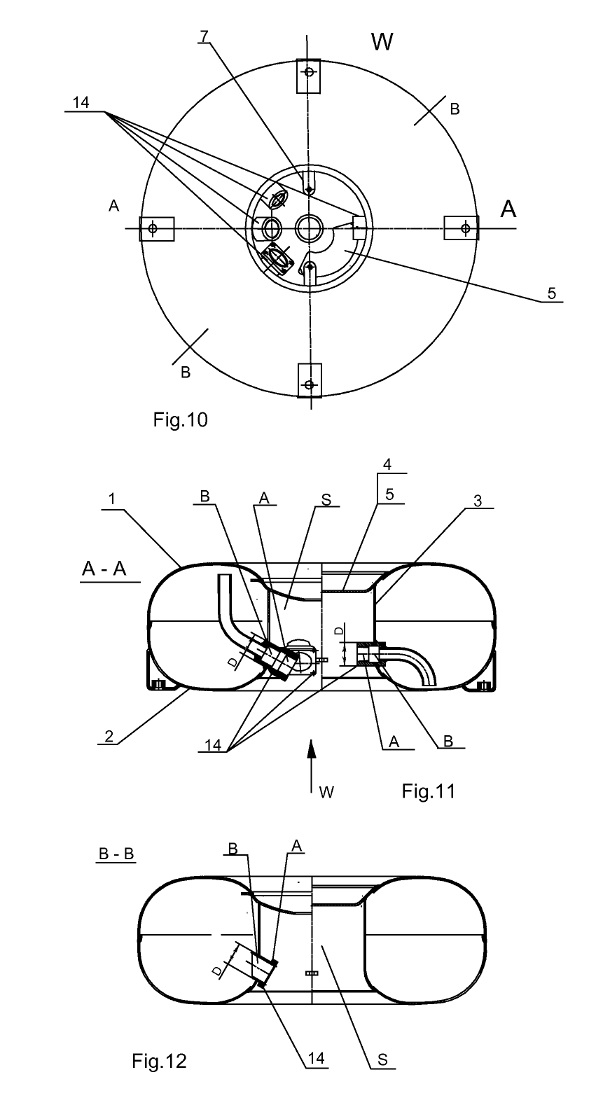

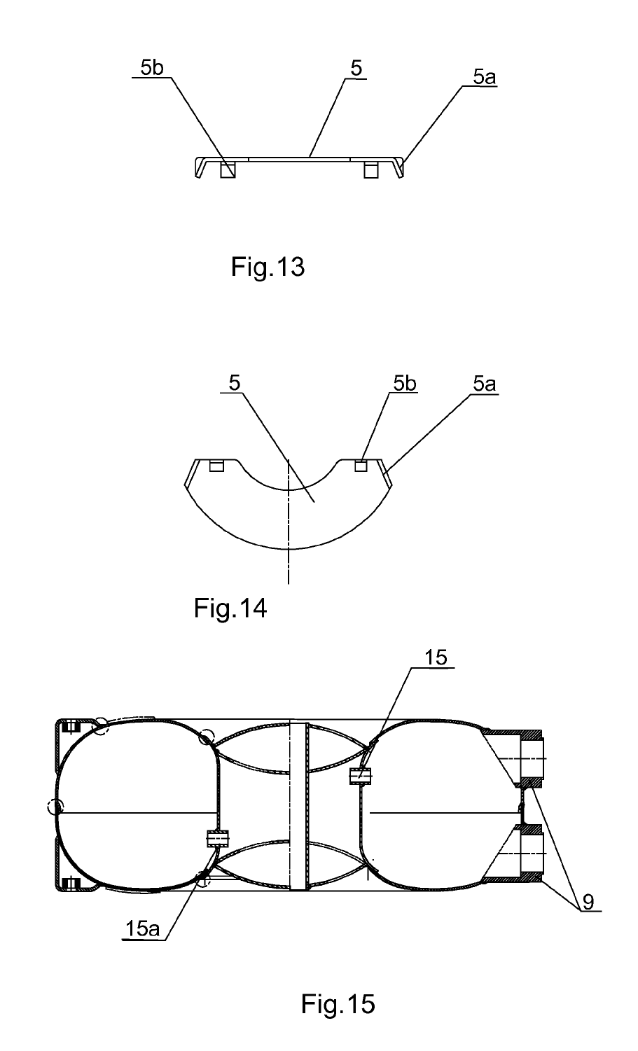

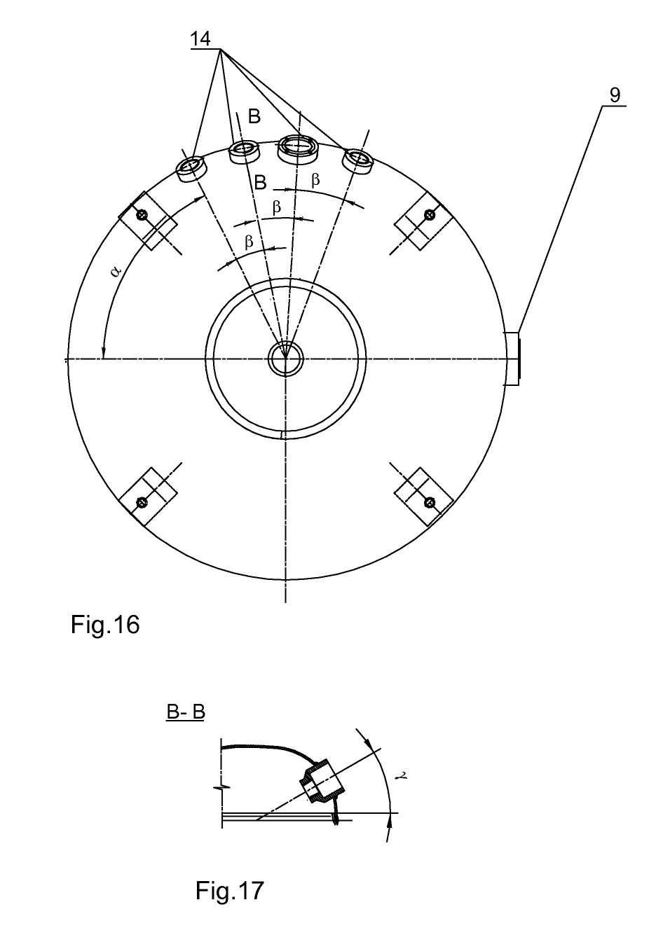

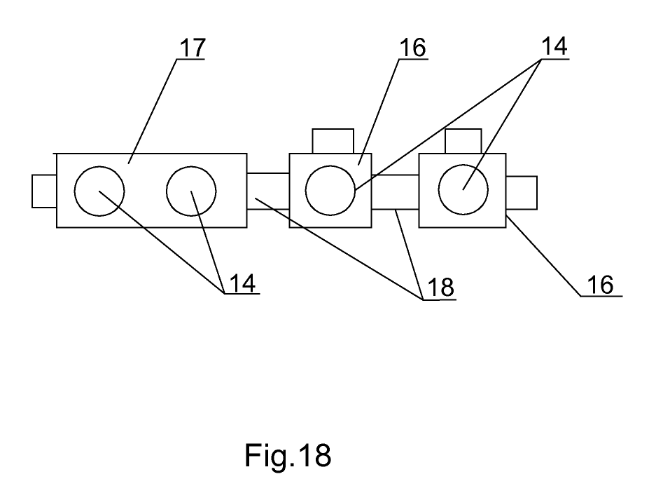

Subject o the invention is shown on the drawings, where FIG. 1 presents cross section of toroidal tank, FIG. 2—cross section of the big volume tank with outer shell and connector pipe as alternative, FIG. 3—view W from FIG. 2, FIG. 4—cross section of central part of the tank, FIG. 5—cross section of the tank with dividers as alternative, FIG. 6—cross section of the tank with dividers, connector pipes in dividers and/or inner bottom for tank equipment, FIG. 7—upper view of the tank with example of connector pipes for equipment, FIG. 8—section B-B from FIG. 7, FIG. 9—cross section A-A of the tank from FIG. 7, FIG. 10—view W of the tank rear, with connector pipes for equipment in lower position, FIG. 11—cross section A-A of toroidal tank in alternative from FIG. 10, FIG. 12—section B-B of the tank in alternative form FIG. 10, FIG. 13—front view of the type plate, FIG. 14—upper view of the type plate, FIG. 15—cross section of alternative with side connector pipes, FIG. 16—upper view of the tank with connector pipes on the circumference of the outer bottom, FIG. 17—section B-B from FIG. 16, FIG. 18—layout of individual covers for particular connector pipes.

Outer, upper bottom 1 with outer, lower bottom 2 create outer shell of the tank, whereas outer bottom 4 is connected with the inner shell 3, creating central, inner part S of the tank, at the same moment connector pipes 9, 9a, 9b and 14 and flow pipes 15, 15a, have lengthwise two zones: zone A—walls with increased thickness and zone B—walls with reduced thickness, beneficially on the whole circumference of the connector pipe, and the wall thickness is between 0.5 up to 1.7 thickness of the tank shell, where the wall thickness is 0.01 up to 2.9 mm and 0.3 up to 1.4 for walls with thickness above 2.90 mm. In the second example, there is central part of the tank, comprising inner bottom 4 and/or inner shell 3, welded between outer bottoms: upper la and lower 2, connected by outer shell 8. Connector pipes 9, 9a, 9b and 14 are welded to elements of the tank shell this way, that the lower end of zone A of connector pipe 9, 9a, 9b and 14 is located at the distance X from the shell 3, not smaller than ⅕ of outer diameter of connector pipe D, and at the same moment the length of weld seam connecting thin wall of connector pipe, located behind the A zone with the tank shell, equals ¼ of the outer diameter of connector pipe in zone B. In central part of the tank S, in inner shell 3 and/or inner bottom 4, are beneficially welded dividers, upper 6 and/or lower 6a.

Flow connectors pipes 15 and 15a are welded to inner bottom 4 and/or upper divider 6 this way, that the part of flow connector pipe 15 and 15a with walls thickness between 0.3 up to 1.7 of elements walls thickness, where it is welded to, is connected with the tank by weld seam not less long than ¼ of the circumference of the connector pipe, in the zone with minimum diameter.

Beneficially connector pipes 9, 9a, 9b for tank equipment are welded into outer shell 3 and/or inner bottom of central part S of the tank and/or in upper divider 6 and lower divider 6a and/or in outer shell 8 and/or outer, upper bottom 1 and lower 2.

Beneficially, connector pipes 14 for tank equipment are located circumferentially in inner shell 3 and/or upper divider 6 and lower 6a and/or in outer shell 8 and/or outer, upper bottom 1 and lower 2. Beneficially, flow connector pipes 15, 15 a are located in tank elements creating walls between particular tank parts, circumferentially placed in outer shell 3 and/or in inner shell 4 and/or upper divider 6 and lower 6a.

Type plate 5 is fixed to inner bottom 4 and/or outer shell 3 and/or upper divider 6 and lower 6a, not far away from tank walls, beneficially fixed point wise, whereas plate 5 may have bend edges 5a and/or located under the plate brackets 5b.

Beneficially, to outer upper bottom 1 and/or lower 2, connector pipes 14 and 9, 9a, 9b are circumferencially welded at the angle α, between 0° and 355° and located at the angle γ between 0° and 90° from the horizontal plane, and the angle β between connectors is between 0° and 355°, whereas connectors may be equipped with separate gas-tight housings 16 and/or integrated housing 17, created by connection through pipes 18 of individual housings of connectors.

Beneficially, elements of central, inner part S, having contact with working medium, are made of material having the thickness not bigger than 3 mm.

Inner bottom 4 and/or upper divider 6 and lower 6a may create type plate for the tank.

Beneficially, brackets 7, 7a, 7b of cover base and/or cover of gas-tight chamber are fixed to surface of inner bottom 4 and/or inner shell 3 and/or upper divider 6 and lower 6a and/or to outer bottoms 1 and 2.

Gas-tight cover is fastened by elastic elements having the form of coiled wire 7a and/or elastic flat bar 7b, fixed to inner bottom 4 and/or outer shell 3 and/or outer bottoms 1 and 2 and/or divider 6, beneficially automatically pressing the base of cover and/or chamber cover with tank equipment and/or sealing of the cover.

1. Pressure tank, especially three-bottoms tank, creating beneficially toroidal tank, comprising connected bottoms, equipped with connector pipes, brackets for fastening the tank and cover, type plate, equipment cover, inner bottom, inner shell, characterized in that, the outer, upper bottom (1) with outer, lower (2) create outer tank shell, whereas inner bottom (4) is connected with outer shell (3), creating central, outer part (S) of the tank, and connector pipes for equipment (9, 9a, 9b and 14) and flow connector pipes (15, 15a) have on their length two zones: zone (A)—with walls of increased thickness and zone (B)—with walls of reduced thickness, beneficially on the whole circumference of the connector pipe, and wall thickness in zone (B) is between 0.5 up to 1.7 of the thickness of tank elements, where the pipe is placed, for walls thick 0.01 up to 2.9 mm and 0.3 up to 1.4 for walls above 2.9 mm.

2. Pressure tank, according to claim 1. characterized in that there is central tank part consisting of inner bottom (4) and/or outer shell (3), welded between outer bottoms: upper (1) and lower (2), connected by outer shell (8).

3. Pressure tank, according to claim 1, characterized in that the connector pipes for equipment (9, 9a, 9b and 14) are welded into elements creating tank walls in that way, that the lower end of (A) zone of connector pipe (9, 9a, 9b and 14) is at distance X to shell wall (3) not smaller than ⅕ of outer diameter of outer connector pipe (D), and the length of welding seam connecting thin wall of connector pipe outside of (A) zone, with tank wall, is ¼ of outer circumference of connector pipe in zone (B), minimum.

4. Pressure tank, according to claim 1, characterized in that in central part (S) oc the tank, in inner shell (3) and/or in inner bottom (4), beneficially upper divider (6) and/or lower (6a) are welded.

5. Pressure tank according to claim 1 or characterized in that the flow connector pipes (15 and 15a) are welded into inner bottom (4) and/or upper divider (6) this way, that part of flow connector pipe (15 and 15a) with walls in area 0.3 up to 1.7 of thickness of element walls, where it is welded, is connected with tank elements by weld seam of the length not less than ¼ of the outer circumference of connector pipe, where it has smallest diameter.

6. Pressure tank, according to claim 1, characterized in that the connector pipes (9,9a, 9b) of tank equipment are beneficially welded into inner shell (3) and/or inner bottom of central part (S) of the tank and/or in upper divider (6) and lower (6a) and/or in outer shell (8) and/or outer, upper bottom (1) and lower (2).

7. Pressure tank, according to claim 1, characterized in that the connector pipes (14) for tank equipment are located circumferentially in inner shell (3) and/or in inner shell (4) and/or upper divider (6) and lower (6a) and/or in outer shell (8) and/or outer, upper bottom (1) and lower (2).

8. Pressure tank, according to claim 1, characterized in that the flow connector pipes (15, 15a) are placed in tank elements creating walls between particular tank elements, are located circumferentially in inner shell (3) and/or in inner bottom (4) and/or upper divider (6) and lower (6a).

9. Pressure tank according to claim 1, characterized in that there is a type plate (5), beneficially fastened point wise, to inner bottom (4) and/or inner shell (3) and/or upper divider (6) and lower (6a), at small distance to tank walls.

10. Pressure tank, according to claim 1, characterized in that there are connector pipes (14) and (9, 9a, 9b) welded to outer, upper bottom (1) and/or lower (2) circumferentially at the angle (α) between 0° up to 355° and located at the angle (γ), between 0° up to 90° to horizontal plane, and the angle (β) between the connector pipes is between 0° up to 355°, whereas the connector pipes are beneficially equipped with gas-tight housings (16) and/or integrated housing (17) created by connecting together individual connector pipes through pipes (18).

11. Pressure tank, according to claim 1, characterized in that the elements in central part (S), having contact with working medium, are made of material not more than 3 mm thick.

12. Pressure tank according to claim 9, characterized in that the type plate (5) has beneficially located bended edges (5a) and/or brackets (5b) under the plate.

13. Pressure tank, according to claim 1, characterized in that the inner bottom (4) and/or upper divider (6) and lower (6a) create the type plate of the tank.

14. Pressure tank according to claim 1, characterized in that the brackets (7, 7a, 7b) of cover base and/or cover of gas-tight chamber are fastened to the surface of inner bottom (4) and/or inner shell (3) and/or upper divider (6) and lower (6a) and/or outer bottoms (1, 2).

15. Pressure tank, according to claim 14, characterized in that the cover of gas-tight chamber is fastened by elastic element from coiled wire (7a) or flat bar (7b), fixed to inner bottom (4) and/or inner shell (3) and/or outer bottoms (1 and 2) and/or divider (6), beneficially automatically pressing the cover base and/or cover of chamber with tank equipment and/or cover sealing.
